(19) United States
(12) Patent Application Publication
(10) Pub. No.: US 2007/0098086 A1
(43) Pub. Date: May 3, 2007

(54) Spatio-temporal noise filter for digital video

(76) Inventor: Vasudev Bhaskaran, Sunnyvale, CA (US)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/261,042

(22) Filed: Oct. 28, 2005

(51) Int. Cl. H04B 1/66

(52) U.S. Cl. 375/240.27; 375/240.29

(57) ABSTRACT

A three-dimensional filter that addresses various types of noise is described. This filter uses both spatial and temporal characteristics of the video signal in the filtering process. Additionally, the filter is able to maintain edge fidelity within in images in the video signal.

### REFERENCE TO RELATED APPLICATIONS

This application relates to U.S. patent application entitled, “Adaptive Video Prefilter,” Ser. No. 10/666,668, filed on Sep. 19, 2003, which is incorporated by reference herein in its entirety.

### BACKGROUND

A. Technical Field

The present invention relates generally to video processing, and more particularly, to an apparatus and method for reducing various types of noise on a digital video signal while maintaining edge fidelity within the video images.

B. Background of the Invention

The importance of digital video technology in the current communications markets is well known. The ability to transmit increasing amounts of video signal data within a constrained bandwidth has allowed the display of video and image content on various devices and platforms. Recent technological advancements within the communications market have facilitated this improvement in the transmission and display of video and image data. One such example is the improvement in coding efficiencies provided by current CODEC devices and associated standards.

Video data may be encoded in order to reduce the amount of data redundancy that is transmitted within a corresponding digital signal. This reduction in redundant data effectively allows video data to be communicated using relatively less bandwidth. In determining how a video signal is to be encoded, oftentimes an analysis is required of both the video data and the communications medium on which the video data is to be transmitted. This analysis is performed in order to ensure that a preferred video or image quality is maintained on a display device.

The presence of noise within a video signal may adversely affect both the coding efficiency of a CODEC that is encoding the video signal and the quality of an image or video stream at a receiving display device. Noise may be generated and undesirably inserted into a signal from various internal and external sources. Two such examples of noise are Gaussian noise and impulse noise.

Gaussian noise is often characterized as a uniform distribution of energy having Gaussian distribution levels over a particular frequency spectrum. Gaussian noise may be generated, for example, as temperature increases in communication equipment and devices resulting in thermal noise that is generated and undesirably inserted into a signal. Comparatively, impulse noise is non-continuous noise pulses within the signal. These noise pulses are oftentimes short in duration and have relatively high amplitudes, and may be generated from both internal and external sources.

The presence of noise within a signal may be measured as a signal to noise ratio (“SNR”). As SNR decreases, the quality of a video signal degrades and adversely affects the ability of a display device to regenerate the particular video. This noise may be generated in various locations within a communication system, such as the system illustrated in FIG. 1.

As shown in this Figure, a video capture device, such as a video camera 110, generates a video signal which is sent to an encoder 115. This encoder 115 encodes the video signal, effectively compressing the signal to remove a level of data redundancy. This encoded signal is communicated via a communications link 120, which may be wired or wireless, to a receive-side decoder 125. The decoder 125 reconstructs the encoded video signal so that it may be shown on the display device 130.

The components within this system 100, as well as sources external to the system 100, may generate noise. Various types of noise filters are currently being used to reduce the amount of noise within a video signal including alpha trimmed filters and median filters. However, these filters typically are designed to address one type of noise within a signal and are less effective at removing other types of noise. Furthermore, these filters often fail to address or leverage certain characteristics of digital video signals when filtering noise.

### SUMMARY OF THE INVENTION

A noise filtering device and method, and embodiments thereof, are described that effectively address different types of noise that may be on a digital video signal by analyzing spatial characteristics, temporal characteristics, and other characteristics of a pixel region within a video signal.

In one embodiment of the invention, a digital video signal is received and a plurality of pixels that span multiple frames within the signal is selected. The plurality of pixels is sorted according to each pixel's significance relative to at least one characteristic of a target pixel that is to be filtered. For example, the plurality of pixels may be sorted into a one-dimensional array according to each pixel's intensity distance from the target pixel.

The sorted pixel array may be shortened by applying a threshold that effectively removes a set of pixels that are the least relevant to the target pixel. For example, if the plurality of pixels is sorted according to intensity distance, then a set of pixels having the largest intensity distance from the target pixel is removed from the array. This set of pixels that is removed is no longer included within the filtering process.

Each pixel within the pixel array is provided a weight coefficient that may further emphasize certain pixels within the filtering process. These weight coefficients may be applied to either the sorted pixel array or the threshold-shortened, depending on if a threshold is applied to the sorted pixel array. In one embodiment, an exponentially decaying set of weight coefficients are used in order to emphasize the pixels most relevant to the target pixel within the filtering process.

Using the weighted, sorted pixel array, a pixel filter is generated and applied to the sorted pixel array. In one embodiment, a weighted alpha-trimmed noise filter is used to filter the target pixel.

Other objects, features and advantages of the invention will be apparent from the drawings, and from the detailed description that follows below.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. (“FIG.”) 1 is an illustration of a communication link on which video data may be transmitted and received.

FIG. 2A is a block diagram of a noise filter and video coder according to one embodiment of the invention.

FIG. 2B is a block diagram of a noise filter and video decoder according to another embodiment of the invention.

FIG. 3 is a block diagram of a spatio-temporal filter according to one embodiment of the invention.

FIG. 4 is an illustration of related pixel blocks and associated pixels therein according to one embodiment of the invention.

FIG. 5 is an illustration of exemplary video frames and pixel blocks therein according to one embodiment of the invention.

FIG. 6A is an illustration of an exemplary pixel string according to one embodiment of the invention.

FIG. 6B is an illustration of an exemplary pixel string and exemplary pixel threshold according to one embodiment of the invention.

FIG. 7 is a block diagram of a noise filter according to one embodiment of the invention.

FIG. 8 is a flowchart illustrating a method for reducing noise based on spatial and temporal characteristics of a pixel according to one embodiment of the invention.

### DETAILED DESCRIPTION OF THE PREFERRED EMBODIMENTS

An apparatus and method for filtering noise on digital video signals based on both spatial and temporal characteristics of a pixel region is described. This three dimensional filter is able to effectively address various types of noise, including Gaussian and impulse nose, and maintain edge fidelity within a video image.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different systems and devices including computers, network servers, wireless devices and other communication devices. The embodiments of the present invention may also be present in software, hardware or firmware. Program instructions in the form of software may be carried on any suitable medium or carrier wave and conveyed to an appropriate device for processing. Structures and devices shown below in block diagram are illustrative of exemplary embodiments of the invention and are meant to avoid obscuring the invention. Furthermore, connections between components and/or modules within the figures are not intended to be limited to direct connections. Rather, data between these components and modules may be modified, re-formatted or otherwise changed by intermediary components and modules.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

A. Overview

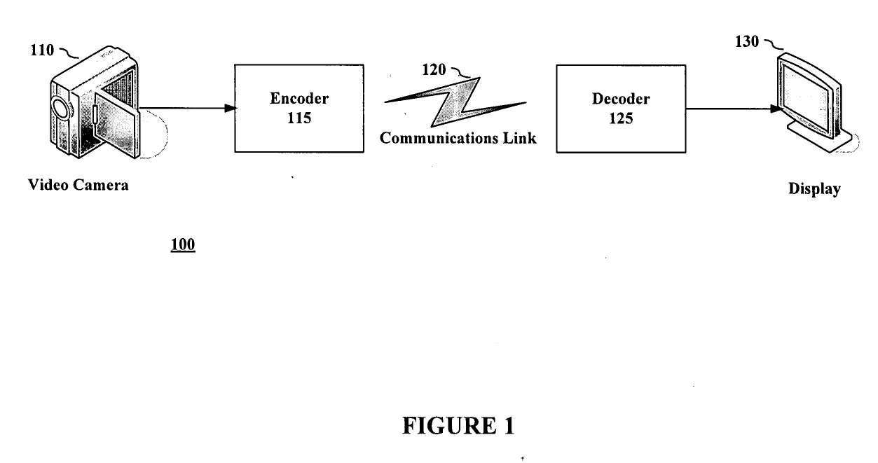

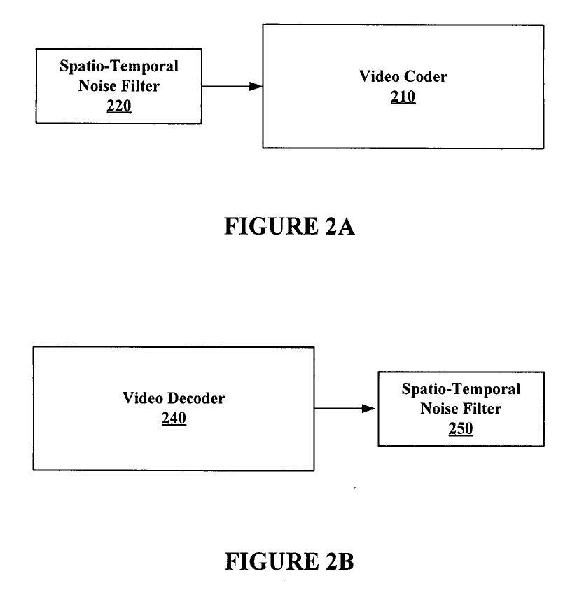

The spatio-temporal noise filter may be positioned in various locations within a digital video communication system. For example, as illustrated in FIG. 2A, a spatio-temporal noise filter 220 may be located before an input on a video coder 210. In this embodiment, the filter 220 reduces noise on a digital signal prior to an encoding process by the video coder 210. For example, noise generated from a video camera sensor may be removed prior to the video signal being encoded. Because this pre-filtering process reduces the amount of noise that would have otherwise been encoded by the video coder 210, a relatively larger amount of the coder's bit budget is used to code the digital video signal.

In another embodiment, a spatio-temporal noise filter 250 may be located at the output of a video decoder 240. This filter 250 removes noise that was coded into the video signal and also noise generated along the video signal path after encoding. As will be described in more detail below, the spatio-temporal filter 250 is able to address various types of noise, such as Gaussian and impulse noise, which may be on the digital video signal. One skilled in the art will recognize that the present spatio-temporal noise filter may be located anywhere along the path of a video signal and integrated within a wide range of digital video applications and devices; all of which are intended to fall within the scope of the present invention.

B. Spatio-Temporal Noise Filter

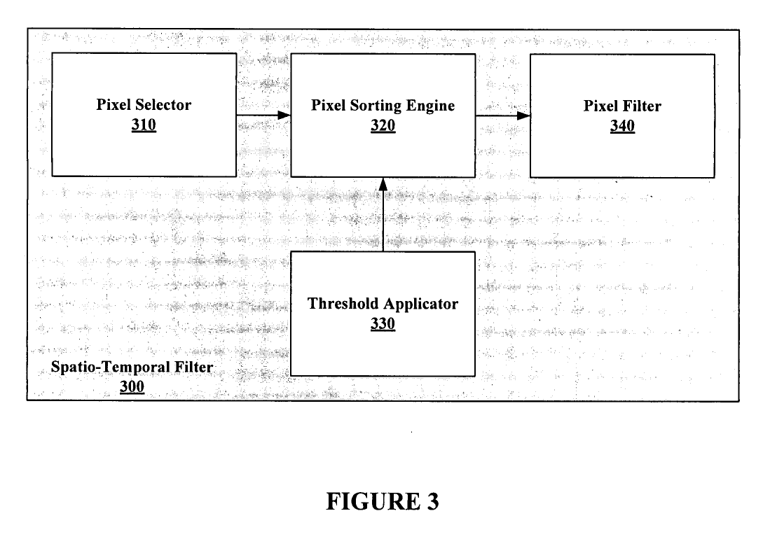

FIG. 3 illustrates one embodiment of a spatio-temporal noise filter 300 that is able to effectively address different types of noise that may be on a digital video signal by analyzing spatial characteristics, temporal characteristics, and other characteristics of a pixel region within a video signal.

This embodiment of the spatio-temporal filter 300 includes a pixel selector 310, a pixel sorting engine 320, and a pixel filter 340. In another embodiment of the invention, the spatio-temporal filter 300 may also include a threshold application module 330.

The pixel selector 310 receives a video signal and selects a plurality of pixels that span multiple video frames. The pixel sorting engine 320 receives the plurality of pixels and sorts them into a one dimensional array in which each pixel's location within the array is identified by its relation to a characteristic of a target pixel that is to be filtered. This sorted array may be shortened by the threshold application module 330 in which a certain number of least relevant pixels are removed from the end of the array.

The pixel filter 340 receives the sorted array and may weight each of the pixels in the array according to various weighting algorithms. In one embodiment, a weighted alpha-trimmed noise filter is used to filter the target pixel. Each of these modules is described in more detail below.

a) Pixel Selector

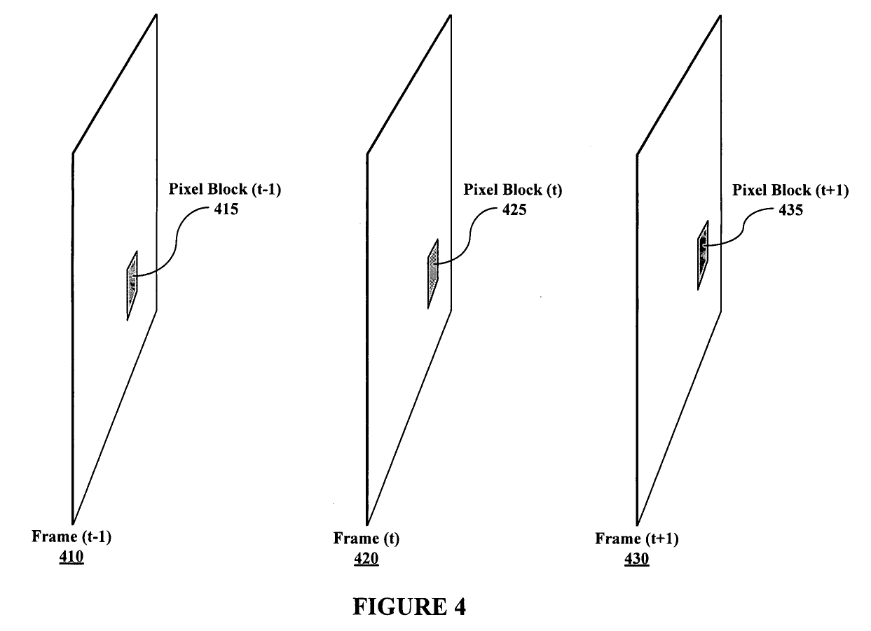

In one embodiment of the invention, a video signal is filtered at a relatively low granularity in which a plurality of pixels are identified and associated with a target pixel that is to be filtered. The plurality of pixels spans multiple video frames within the video signal. For example, such video frames are illustrated in FIG. 4, in which three sequential frames are shown. Frame (t) 420 contains spatial domain samples for the video frame at time instant t, frame (t−1) 410 contains spatial domain samples for the video frame at time instant t−1, and frame (t+1) 430 contains spatial domain samples for the video frame at time instant t+1.

A first pixel block 425 having a target pixel, which is to be filtered and located at the center of the first pixel block 425, is identified within frame (t) 420. A second pixel block 415 within frame (t−1) 410 is identified as relating to the first pixel block 425. A third pixel block 435 within frame (t+1) 430 is also identified as relating to the first pixel block 425. In one embodiment of the invention, the blocks 415, 425, 435 are collocated blocks in sequential frames. In another embodiment of the invention, the blocks 415, 425, 435 may follow motion vectors through the sequential frames, which would allow a filtering process along an associated motion trajectory. These motion vectors may be identified within a coded signal, such as an H.264 video encoded stream, and used within the filtering process or otherwise identified and/or generated during the filtering process. Other techniques, such as optic flow or an analysis of video frame homogeneity characteristics, may also be used to identify motion trajectories between the sequential frames. Accordingly, if the relevant video image is not static within the frame sequence, a more relevant, spatially-shifted set of blocks may be identified.

The blocks 415, 425, 435 may be defined as having various sizes and shapes. In one embodiment of the invention, each block is a 3×3 pixel block, with the target pixel located within the center of the first block 425. The actual size and shape of the blocks may vary depending on the video signal and noise characteristics that are being filtered. Although it may be difficult to identify these characteristics a priori, such identification may be performed and used to modify the block sizes, shapes, etc. Additionally, the size of the blocks may affect the speed of the filtering process and resources required therein.

In yet another embodiment of the invention, the characteristics of the frames may be used to refine the filtering process. For example, if a scene change should occur between frame (t) 420 and frame (t+1), then the third pixel block 435 is likely not relevant to the first pixel block 425 and may be excluded. This scene change may be identified by various methods including globally averaging each frame and identifying a difference between frames. If the global average difference is above a threshold, then a scene change may be inferred. Additionally, encoding information may also be leveraged to identify whether a scene change has occurred or a relevant image within a frame has disappeared in a subsequent frame.

The spatio-temporal filter may also recognize when frames are not provided in sequence, such as an interlaced video stream or if frames are being lost or discarded during transmission. In these situations, the selection of blocks may be adjusted in response to the non-sequential video frames or the filter may simply be turned off.

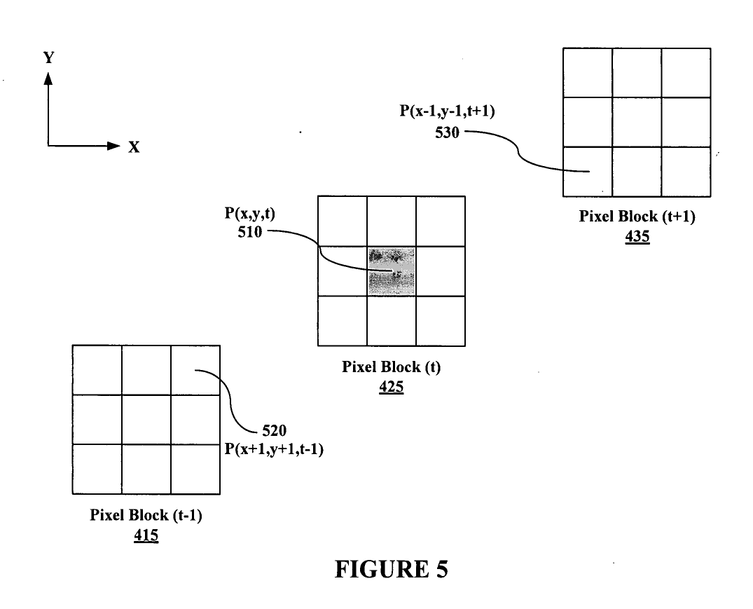

FIG. 5 illustrates an exemplary plurality of pixel blocks in which individual pixels within the blocks may be spatially and temporally related to a target pixel P(x,y,t) 510 along x, y and t axes. For example, as shown in this illustration, a bottom left pixel 530 within the third block 435 may be identified as P(x−1, y−1, t+1) and an upper right pixel 520 within the first block 415 may be identified as P(x+1, y+1, t−1).

b) Pixel Sorting Engine

Once the plurality of pixels is identified, the pixels are sorted into an array according to relevance to the target pixel 510 as defined by a particular characteristic. For example, in one embodiment of the invention, the sorting process is done on the luminance channel so that the plurality of pixels is sorted according to each pixel's intensity distance from the target pixel 510 such that:
|P₁−Pᵢ|≦|Pᵢ−Pⱼ|

where i=2, . . . , N and j=i, . . . , N and P₁=the target pixel

Thus, filtering operations may be performed solely on the Y-channel of a video signal. Other pixel characteristics may also be used in the sorting process in order to sequence the plurality of pixels relative to a filtering operation or process.

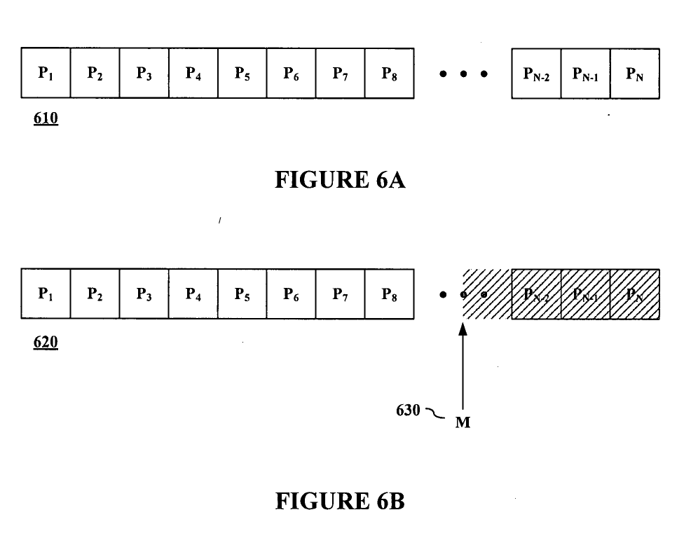

One skilled in the art will recognize that various sort operations may be used, such as a binary sort, a quick sort, etc., in order to sort the plurality of pixels into a one dimensional array. FIG. 6A illustrates an exemplary sorted pixel array 610 comprising N pixels and P₁ is the target pixel 510. If three 3×3 blocks are used, as described above, then N would be equal to 27.

c) Threshold Application

The sorted pixel array 610 may be shortened to exclude the least relevant pixels located at the end of the array. In one embodiment, a threshold is applied to the sorted pixel array 610 to exclude certain pixels located at the end of the array. A resulting shortened array 620 is created having M pixels 630, wherein M is less than N.

The threshold may be determined using various methods that improve the filtering process relative to the noise and video characteristics of the signal. In one embodiment of the invention, M may be defined based on experiment. For example, if 3×3 blocks are used, then an M value of 18 has been shown to be effective in the filtering process. In this scenario, the 9 least relevant pixels are excluded and no longer used in subsequent filtering operations for a particular target pixel.

In another embodiment of the invention, M may be dynamically adapted based on an analysis of the noise and/or video characteristics of a video signal. One skilled in the art will recognize that various techniques may be used to analyze these characteristics. Additionally, an analysis of edge properties and smoothing effects on images within the signal may be performed to dynamically adjust the threshold value. In yet another embodiment, the quantization within an encoded video signal may be used to predict an appropriate threshold value. For example, if aggressive quantization is used within an encoding process, a high threshold may be used to compensate and smooth image artifacts more aggressively.

The shortened sorted pixel array 620 functions to remove the effect of impulse noise on the filtered target pixel 510. In particular, if the pixel array 610 is sorted according to intensity distance, then those pixels with impulse noise will be located at the end of the array. Thus, as the threshold is applied, the impulse noise will not be present within the shortened sorted pixel array 620 and will not affect the value of the filtered target pixel 510.

d) Filter

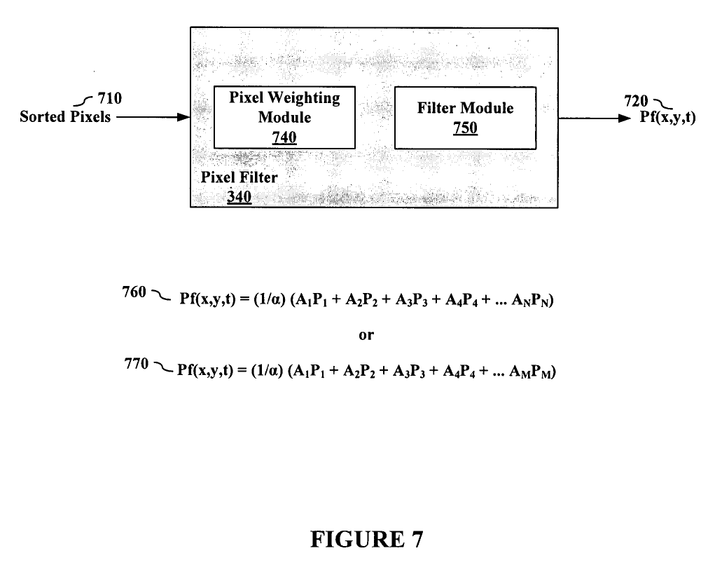

FIG. 7 illustrates one embodiment of the pixel filter 340 that receives a sorted pixel array 710, which may or may not have been shortened by the application of a threshold, and provides a filtered target pixel value 720. This embodiment of the pixel filter 340 includes a pixel weighting module 740 and a filter module 750.

The pixel weighting module 740 applies a plurality of weight coefficients to the sorted pixel array 710. The sorted pixel array 710 may have N pixels or may have M pixels if a threshold had been previously applied. Examples of such a weighted sorted pixel array are:
A₁P₁+A₂P₂+A₃P₃+ . . . A_{N}P_{N}; or
A₁P₁+A₂P₂+A₃P₃+ . . . A_{M}P_{M}

The values of the weight coefficients (i.e., A₁, A₂, A₃, . . . ) may be defined according to various methods. In one embodiment, the weight coefficients decays such that:
A₁≧A₂≧A₃≧ . . .

The use of decaying weight coefficients emphasizes the most relevant pixels within the sorted pixel array during the filtering process. For example, the weight coefficients may follow an exponential decay corresponding to a particular correlation function. In another embodiment, the weight coefficients are equal resulting in each pixel within the sorted pixel array having the same emphasis during the filtering process. In yet another embodiment, if the noise characteristics of a video signal are known, then the weight coefficients may be designed to specifically address and filter this noise on the video signal. Other methods may be used to supplement or modify the use of the sorted pixel array within the filtering process.

In one embodiment of the invention, the filter module 750 receives the weighted sorted pixel array and filters the target pixel using this array. A filtered target pixel Pf(x,y,t) is calculated as:
Pf(x,y,t)=(1/α)(A₁P₁+A₂P₂+A₃P₃+ . . . A_{N}P_{N})
where α=(A₁+A₂+A₃+ . . . A_{N})

If the weighted sorted pixel array was reduced to M elements by the application of the threshold, then Pf(x,y,t) is calculated as:
Pf(x,y,t)=(1/α)(A₁P₁+A₂P₂+A₃P₃+ . . . A_{M}P_{M})
where α=(A₁+A₂+A₃+ . . . A_{M}) and where M<N

The edges within the video image are relatively well preserved during the noise reduction process. In particular, edge fidelity is maintained because pixels within the sorted array that are close to the target pixel P(x,y,t) intensity will be emphasized in the filtering process and reduce any smoothing effects that may have otherwise occurred.

Various types of noise are addressed by this three dimensional filter because of the threshold that removes a set of least relevant pixels from the sorted array. For instance, if impulse noise is present on a pixel, other than the target pixel, then this impulse noise will be located at or near the end of the sorted pixel array. After a threshold is applied, this impulse noise is removed and does not affect the value of the filtered pixel Pf(x,y,t). Furthermore, if Gaussian noise is present, then the averaging operation of the three dimensional filter reduces the affects of this Gaussian noise at the filtered target pixel Pf(x,y,t).

The implementation of the three dimensional filter may be realized using various techniques to improve performance and/or reduce storage capacity and computation complexity. For example, M may be chosen as a power of two which would result in a being a power of two. Accordingly, the divide operation within the filtering process may be replaced by a simple shift operation. Furthermore, the decay on the weight factors (i.e., A₁, A₂, A₃, . . . ) may be defined as exponentially decaying by a power of two which would also simplify the implementation of mathematical operations within the filter. These implementations may reduce the complexity of the filtering computations and may allow the filter to be integrated within an ASIC, software, firmware or other medium structure.

C. Method of Three Dimensional Noise Filtering

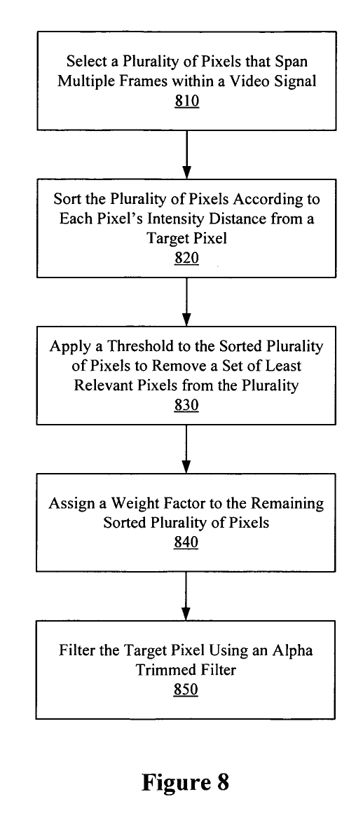

FIG. 8 illustrates a method for filtering noise from a video signal, independent of structure, according to one embodiment of the invention.

A plurality of pixels that span multiple frames within a video signal is selected 810. This selection of pixels may correspond to a motion trajectory through multiple video frames or may be defined using collocated blocks within the multiple frames.

The plurality of pixels is sorted 820 according to each pixel's intensity distance from a target pixel that is to be filtered. One skilled in the art will recognize that other pixel characteristics may also be used to sort the plurality of pixels, all of which are intended to fall within the scope of the present invention.

A threshold is applied 830 to the sorted plurality of pixels to remove a set of least relevant pixels and reduce the size of the plurality of pixels. This threshold may be generated, defined, modified, or otherwise maintained using various techniques. Furthermore, this threshold value may be set prior to filtering a video signal or be adjusted in real time as the video signal is being filtered.

The remaining plurality of pixels is assigned 840 weight coefficients that may emphasize certain pixels within the remaining plurality of pixels. Accordingly, pixels that are more relevant to the target pixel may be provided higher weight values and be more relevant in the filtering process.

The weighted plurality of pixels is used 850 to filter the target pixel using a filter in which spatial, temporal and intensity characteristics of a pixel region are addressed in the filtering process. One skilled in the art will recognize that various other types of filters may be used in this filtering process. This filtering process addresses various types of noise that may be present on the video signal and maintains edge fidelity within video images.

While the present invention has been described with reference to certain exemplary embodiments, those skilled in the art will recognize that various modifications may be provided. Accordingly, the scope of the invention is to be limited only by the following claims.

We claim:

1. A method for reducing noise in a digital video, the method comprising:
selecting a plurality of pixels, which span multiple video frames, and identifying a target pixel associated with the plurality of pixels;
sorting the plurality of pixels according to each pixel's intensity distance from the target pixel;
assigning each pixel, within the sorted plurality of pixels, a weighted coefficient according to its relative intensity distance from the target pixel, wherein the values of the weighted coefficients decrease as the pixel intensity distances increase;
generating a filter according to the assigned weighted coefficients and pixel values of the plurality of pixels; and
applying the filter to the target pixel.

2. The method of claim 1 wherein the plurality of pixels is selected along a motion trajectory within the multiple video frames.

3. The method of claim 1 wherein the filter is generated using an alpha trimmed filter.

4. The method of claim 1 further comprising the step of reducing the number of pixels within the sorted plurality of pixels, prior to identifying a filtered value for the target pixel, according to a threshold resulting in the removal of a set of pixels having a relatively higher intensity distance from the target pixel.

5. The method of claim 4 wherein the sorted plurality of pixels is reduced to a number that is a factor of two.

6. The method of claim 1 wherein the weighted coefficients are a set of exponentially decaying values.

7. A medium or waveform containing program instructions adapted to direct the performance of the method of claim 1.

8. A spatio-temporal filter for reducing noise on a video signal, the filter comprising:
a pixel selector, coupled to receive the video signal, that selects a plurality of pixels spanning multiple frames within the video signal and associates the plurality of pixels with a target pixel;
a pixel sorting engine, coupled to receive the selected plurality of pixels, that sorts the plurality of pixels according to each pixel's intensity distance from the target pixel; and
a filter, coupled to receive the sorted plurality of pixels, that assigns a weight coefficient for each of the pixels within the sorted plurality of pixels and generates a filter for the target pixel.

9. The filter of claim 8 further comprising a threshold application module, coupled to access the sorted plurality of pixels, that reduces the number of pixels within the sorted plurality of pixels according to each pixel's intensity distance from the target pixel.

10. The filter of claim 9 wherein the threshold application module reduces the number of pixels within the sorted plurality of pixels to a number that is a power of two.

11. The filter of claim 8 wherein the plurality of pixels is selected according to a motion trajectory through the multiple frames within the video signal.

12. The filter of claim 11 wherein the target pixel is located in the center of a pixel block having a subset of pixels within the selected plurality of pixels.

13. A method for reducing noise within a digital video frame, the method comprising:
selecting a plurality of pixels, which span multiple video frames, and associating the target pixel with the plurality of pixels;
sorting the plurality of pixels according to a pixel characteristic relative to a target pixel;
assigning each pixel, within the sorted plurality of pixels, a weighted coefficient according to its relative importance to the target pixel;
generating a filter according to the assigned weighted coefficients and pixel values of the plurality of pixels; and
applying the filter to the target pixel.

14. The method of claim 13 wherein the pixel characteristic is pixel intensity distance from the target pixel.

15. The method of claim 13 wherein the plurality of pixels is selected along a motion trajectory through the multiple video frames.

16. The method of claim 15 wherein the plurality of pixels is selected according to at least one motion vector embedded within the video signal.

17. The method of claim 13 wherein the plurality of pixels are sorted into a one dimensional array of pixels.

18. The method of claim 13 further comprising the step of reducing the number of pixels within the sorted plurality of pixels, prior to generating the filter, according to a threshold resulting in the removal of a set of pixels that are less relevant to the target pixel.

19. The method of claim 18 wherein the number of pixels within the sorted plurality of pixels is a power of two after the threshold is applied.

20. A medium or waveform containing program instructions adapted to direct the performance of the method of claim 13.
